(19) United States
(12) Patent Application Publication
(10) Pub. No.: US 2019/0114185 A1
(43) Pub. Date: Apr. 18, 2019

(54) SIMULATION DEVICE, INFORMATION PROCESSING APPARATUS, DEVICE SETTING METHOD AND NON-TRANSITORY COMPUTER-READABLE RECORDING MEDIUM ENCODED WITH DEVICE SETTING PROGRAM

(71) Applicant: Konica Minolta, Inc., Tokyo (JP)

(72) Inventors: Tomoaki Nakajima, Kobe-shi (JP); Hisashi Uchida, Kuse-gun (JP); Hiroaki Kubo, Muko-shi (JP); Yasutaka Ito, Amagasaki-shi (JP); Hideaki Soejima, Amagasaki-shi (JP); Yoshiaki Shibuta, Itami-shi (JP)

(73) Assignee: Konica Minolta, Inc., Tokyo (JP)

(21) Appl. No.: 16/159,890

(22) Filed: Oct. 15, 2018

(30) Foreign Application Priority Data
Oct. 16, 2017 (JP) 2017-200364

(51) Int. Cl. G06F 9/455; H04N 1/00; G06F 3/12

(52) U.S. Cl. CPC G06F 9/455; H04N 1/0001; G06F 3/1263; H04N 2201/0094; G06F 3/1205; G06F 3/1208; G06F 3/124

(57) ABSTRACT

A simulation device includes a hardware processer that simulates an apparatus. When an state of the apparatus does not satisfy a allowable condition, the hardware processor determines a group of the plurality of jobs being executed as an error group, and allows a virtual device to carry out a plurality of jobs that are generated when a parameter defined by at least one of the plurality of jobs included in the error group is changed. When a state of the virtual device satisfies the allowable condition, the hardware processor determines a group of the plurality of jobs executed as a change job group. When the apparatus carries out a plurality of new jobs, the hardware processor allows the apparatus to change each of parameters of the plurality of new jobs to a parameter defined by a change job included in the change job group.

### CROSS-REFERENCE TO RELATED APPLICATIONS

Japanese Patent Application No. 2017-200364 filed on Oct. 16, 2017, is incorporated herein by reference in its entirety.

### BACKGROUND

### Technological Field

The present invention relates to a simulation device, an information processing apparatus, a device setting method and a non-transitory computer-readable recording medium encoded with a device setting program. More specifically, the present invention relates to a simulation device that simulates an information processing apparatus, a device setting method performed in the information processing apparatus or the simulation device, and a non-transitory computer-readable recording medium encoded with a device setting program which allows a computer to perform a virtual execution method.

### Description of the Related Art

A multi function peripheral has a plurality of functions such as a scanning function of scanning a document, an image forming function of making prints based on print data and a facsimile function of transmitting and receiving a facsimile. Further, the multi function peripheral can process a plurality of types of data in different formats as the data to be processed, and performs different processes according to the types of data. The functions to be used out of the plurality of functions of the multi function peripheral differ according to the jobs executed by the multi function peripheral. The jobs executed by the multi function peripheral differ according to the use environment of the multi function peripheral such as different users of the multi function peripheral. Further, the multi function peripheral can execute a plurality of jobs in parallel. Thus, a load may increase for specific combinations of a plurality of types of jobs, and processing speeds for all of the plurality of types of jobs are lowered.

Generally, a technique for reproducing bugs in another device has been known in order to find bugs of the device. For example, Japanese Patent Laid-Open No. 10-111815 discloses a debug system that is used in a system including a high-speed digital synchronization circuit or a high-speed interface, an internal operation of which cannot be observed, and is characterized in that the debug system includes an output means for synchronizing an input signal between elements of the system with a system lock and outputting a signal, an storage means for snooping the output signal of the output means and storing the signal as stored information, and a first reproduction means for reproducing an internal operation of the synchronization circuit or the high-speed interface of the system using the stored information.

While bugs can be found in the conventional debug system, a user must work on fixing the found bugs.

### SUMMARY

According to one or more embodiments of the present invention, a simulation device includes a hardware processer that simulates an information processing apparatus that executes a job defining a process and a parameter indicating contents of the process, in the case where an operation state of the information processing apparatus that carries out parallel execution of a plurality of jobs does not satisfy a preset allowable condition, determines a group of the plurality of jobs being executed by the information processing apparatus as an error group, allows a virtual device that simulates the information processing apparatus to carry out parallel execution of a plurality of jobs that are generated when a parameter defined by at least one of the plurality of jobs included the error group is changed, in the case where an operation state of the virtual device satisfies the allowable condition, determines a group of the plurality of jobs executed by the virtual device as a change job group, and in the case where the information processing apparatus carries out parallel execution of a plurality of new jobs, processes of which are same as processes of the plurality of jobs that belong to the error group and parameters of which are same as or differ in a predetermined manner from the parameters of the plurality of jobs that belong to the error group, allows the information processing apparatus to change each of parameters of the plurality of new jobs to the parameter defined by a change job, a process of which is same as a process of the new job, out of a plurality of change jobs included in the change job group.

According to one or more embodiments of the present invention, an information processing apparatus includes a hardware processer that, in the case where a preset allowable condition becomes unsatisfied during parallel execution of a plurality of jobs each of which defines a process and a parameter indicating contents of the process, determines a group of the plurality of jobs as an error group, determines a group, including a plurality of jobs at least one of which defines a parameter different from a parameter defined by a corresponding job of the plurality of jobs included in the error group and satisfying the allowable condition during parallel execution, as a change job group, and in the case where a plurality of new jobs, processes of which are same as processes of the plurality of jobs that belong to the error group and parameters of which are same as or differ in a predetermined manner from the parameters of the plurality of jobs that belong to the error group, are executed, changes each of parameters of the plurality of new jobs to the parameter defined by a change job, a process of which is same as a process of the new job, out of a plurality of change jobs included in the change job group.

According to one or more embodiments of the present invention, a device setting method includes simulating an information processing apparatus that executes a job defining a process and a parameter indicating contents of the process, in the case where an operation state of the information processing apparatus that carries out parallel execution of a plurality of jobs does not satisfy a preset allowable condition, determining a group of the plurality of jobs being executed by the information processing apparatus as an error group, allowing a virtual device that simulates the information processing apparatus to carry out parallel execution of a plurality of jobs that are generated when a parameter defined by at least one of the plurality of jobs included the error group is changed, in the case where an operation state of the virtual device satisfies the allowable condition, determining a group of the plurality of jobs executed by the virtual device as a change job group, and in the case where the information processing apparatus carries out parallel execution of a plurality of new jobs, processes of which are same as processes of the plurality of jobs that belong to the error group and parameters of which are same as or differ in a predetermined manner from the parameters of the plurality of jobs that belong to the error group, allowing the information processing apparatus to change each of parameters of the plurality of new jobs to the parameter defined by a change job, a process of which is same as a process of the new job, out of a plurality of change jobs included in the change job group.

According to one or more embodiments of the present invention, a device setting method includes, in the case where a preset allowable condition becomes unsatisfied during parallel execution of a plurality of jobs each of which defines a process and a parameter indicating contents of the process, determining a group of the plurality of jobs as an error group, determining a group, including a plurality of jobs at least one of which defines a parameter different from a parameter defined by a corresponding job of the plurality of jobs included in the error group and satisfying the allowable condition during parallel execution, as a change job group, and in the case where a plurality of new jobs, processes of which are same as processes of the plurality of jobs that belong to the error group and parameters of which are same as or differ in a predetermined manner from the parameters of the plurality of jobs that belong to the error group, are executed, changing each of parameters of the plurality of new jobs to the parameter defined by a change job, a process of which is same as a process of the new job, out of a plurality of change jobs included in the change job group.

According to one or more embodiments of the present invention, a non-transitory computer-readable recording medium encoded with a device setting program allows a computer to simulate an information processing apparatus that executes a job defining a process and a parameter indicating contents of the process, in the case where an operation state of the information processing apparatus that carries out parallel execution of a plurality of jobs does not satisfy a preset allowable condition, determine a group of the plurality of jobs being executed by the information processing apparatus as an error group, allow a virtual device that simulates the information processing apparatus to carry out parallel execution of a plurality of jobs that are generated when a parameter defined by at least one of the plurality of jobs included the error group is changed, in the case where an operation state of the virtual device satisfies the allowable condition, determine a group of the plurality of jobs executed by the virtual device as a change job group, and in the case where the information processing apparatus carries out parallel execution of a plurality of new jobs, processes of which are same as processes of the plurality of jobs that belong to the error group and parameters of which are same as or differ in a predetermined manner from the parameters of the plurality of jobs that belong to the error group, allow the information processing apparatus to change each of parameters of the plurality of new jobs to the parameter defined by a change job, a process of which is same as a process of the new job, out of a plurality of change jobs included in the change job group.

According to one or more embodiments of the present invention, a non-transitory computer-readable recording medium encoded with a device setting program, the device setting program allows a computer to, in the case where a preset allowable condition becomes unsatisfied during parallel execution of a plurality of jobs each of which defines a process and a parameter indicating contents of the process, determine a group of the plurality of jobs as an error group, determine a group, including a plurality of jobs at least one of which defines a parameter different from a parameter defined by a corresponding job of the plurality of jobs included in the error group and satisfying the allowable condition during parallel execution, as a change job group, and in the case where a plurality of new jobs, processes of which are same as processes of the plurality of jobs that belong to the error group and parameters of which are same as or differ in a predetermined manner from the parameters of the plurality of jobs that belong to the error group, are executed, change each of parameters of the plurality of new jobs to the parameter defined by a change job, a process of which is same as a process of the new job, out of a plurality of change jobs included in the change job group.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing one example of an overview of an information processing system in one or more embodiments of the present invention;

FIG. 2 is a block diagram showing one example of an outline of a hardware configuration of a server in one or more embodiments of the present invention;

FIG. 3 is a block diagram showing one example of an outline of a hardware configuration of an MFP in one or more embodiments of the present invention;

FIG. 4 is a block diagram showing one example of a detailed configuration of a main board in one or more embodiments of the present invention;

FIG. 5 is a diagram showing one example of an outline of a simulator included in the server;

FIG. 6 is a block diagram showing one example of functions of a CPU included in the MFP in one or more embodiments of the present invention;

FIG. 7 is a block diagram showing one example of functions of a CPU included in the server in one or more embodiments of the present invention;

FIG. 8 is a diagram showing one example of results of simulation when settings of one job are changed;

FIG. 9 is a flow chart showing one example of a flow of a device setting process;

FIG. 10 is a flow chart showing one example of a specific operation process;

FIG. 11 is a flow chart showing one example of a flow of a specific operation determination process;

FIG. 12 is a diagram showing part of one example of results of simulation when the settings of two jobs are changed; and

FIG. 13 is a diagram showing part of one example of results of simulation when settings of the three jobs are changed.

### DETAILED DESCRIPTION

Hereinafter, embodiments of the present invention will be described with reference to the drawings. However, the scope of the invention is not limited to the disclosed embodiments.

Embodiments of the present invention will be described below with reference to the drawings. In the following description, the same parts are denoted with the same reference characters. Their names and functions are also the same. Thus, a detailed description thereof will not be repeated.

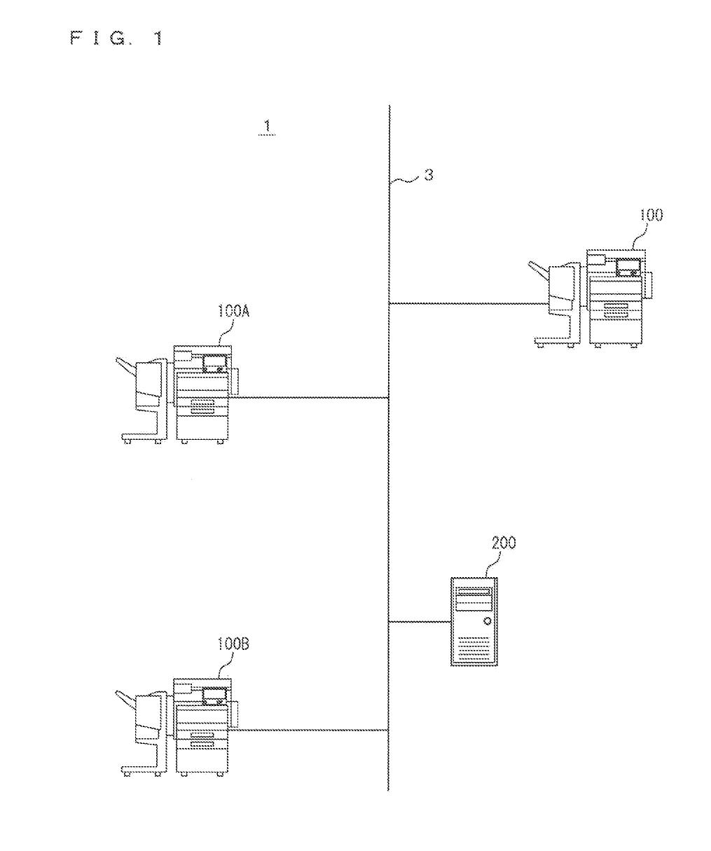

FIG. 1 is a diagram showing one example of an overview of an information processing system in one or more embodiments of the present invention. Referring to FIG. 1, the information processing system 1 includes MFPs (Multi Function Peripherals) 100, 100A, 100B and a server 200.

The MFPs 100, 100A, 100B are one example of an image forming apparatus, and includes at least an image forming function of forming an image on a recording medium such as a paper (a sheet of paper) based on image data. In addition to the image forming function, the MFPs 100, 100A, 100B may include a document scanning function of scanning a document and a facsimile transmission reception function of transmitting and receiving facsimile data. The server 200 is a general computer.

The server 200 and the MFPs 100, 100A, 100B are respectively connected to a network 3. The network 3 is a Local Area Network (LAN), either wired or wireless. The network 3 may further be connected to the Internet. In this case, the server 200 and the MFPs 100, 100A, 100B can respectively communicate with the computer connected to the Internet via the network 3. Further, the network 3 is not limited to a LAN and may be a network using Public Switched Telephone Networks. Further, the network 3 may be a Wide Area Network (WAN) such as the Internet.

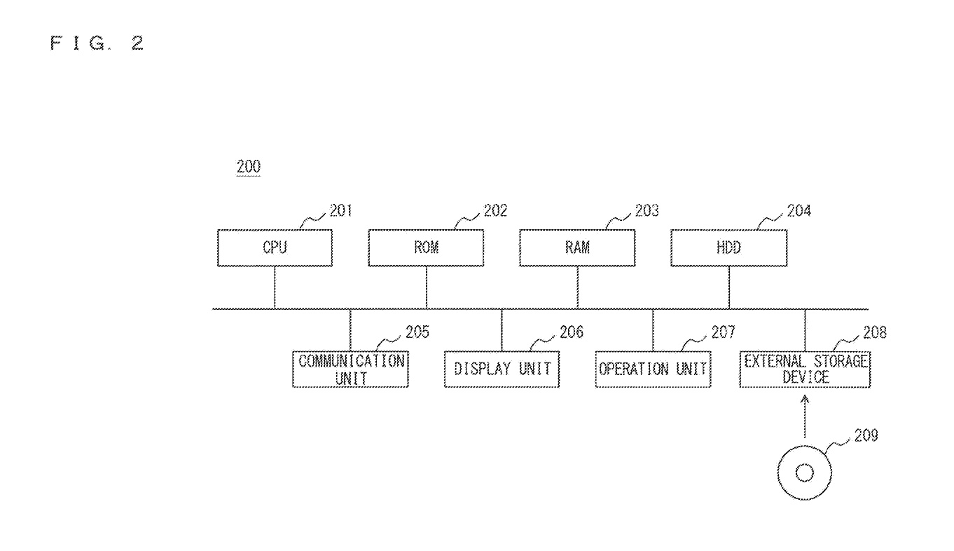

FIG. 2 is a block diagram showing one example of an outline of a hardware configuration of a server in one or more embodiments of the present invention. Referring to FIG. 2, the server 200 includes a Central Process Unit (CPU) 201 for controlling the server 200 as a whole, a ROM (Read Only Memory) 202 for storing a program to be executed by the CPU 201, a RAM (Random Access Memory) 203 that is used as a work area for the CPU 201, a Hard Disc Drive (HDD) 204 that stores data in a non-volatile manner, a communication unit 205 that connects the CPU 201 to the network 3, a display unit 206 that displays information, an operation unit 207 that accepts a user input operation and an external storage device 208.

The display unit 206 is a display device such as a Liquid Crystal Display (LCD) device and an organic ELD (Electro-Luminescence Display). The operation unit 207 is hard keys such as a keyboard. Further, the operation unit 207 may be a touch panel. The touch panel is superimposed on an upper or lower surface of the display unit 206. The touch panel detects the position designated by the user in a display surface of the display unit 206.

The communication unit 205 is an interface for connecting the CPU 201 to the network 3. The communication unit 205 communicates with the MFPs 100, 100A, 100B connected to the network using a communication protocol such as a TCP (Transmission Control Protocol) or a UDP (User Datagram Protocol). The protocol for communication is not limited in particular, and any protocol can be used. IP (Internet Protocol) addresses of the MFPs 100, 100A, 100B are respectively registered in the server 200, so that the server 200 can communicate with the respective MFPs 100, 100A, 100B and can transmit and receive data.

The HDD 204 stores the program executed by the CPU 201 and the data necessary for the execution of the program. The CPU 201 loads the program recorded in the HDD 204 into the RAM 203 for execution.

The external storage device 208 is mounted with a CD-ROM (Compact Disk ROM) 209 storing a program. The CPU 201 is capable of accessing the CD-ROM 209 via the external storage device 208. The CPU 201 loads the program, recorded in the CD-ROM 209 which is mounted on the external storage device 208, into the RAM 203 for execution. It is noted that the medium for storing the program executed by the CPU 201 is not limited to the CD-ROM 209. It may be an optical disc (MO (Magnetic Optical Disc)/MD (Mini Disc)/DVD (Digital Versatile Disc)), an IC card, an optical card, and a semiconductor memory such as a mask ROM and an EPROM (Erasable Programmable ROM).

Further, the program executed by the CPU 201 is not limited to a program recorded in the CD-ROM 209, and the CPU 201 may load a program, stored in the HDD 204, into RAM 203 for execution. In this case, another computer connected to the network 3 may rewrite the program stored in the HDD 204, or may additionally write a new program therein. Further, the server 200 may download a program from another computer connected to the network 3 or the Internet, and store the program in the HDD 204. The program referred to here includes not only a program directly executable by the CPU 201 but also a source program, a compressed program, an encrypted program or the like.

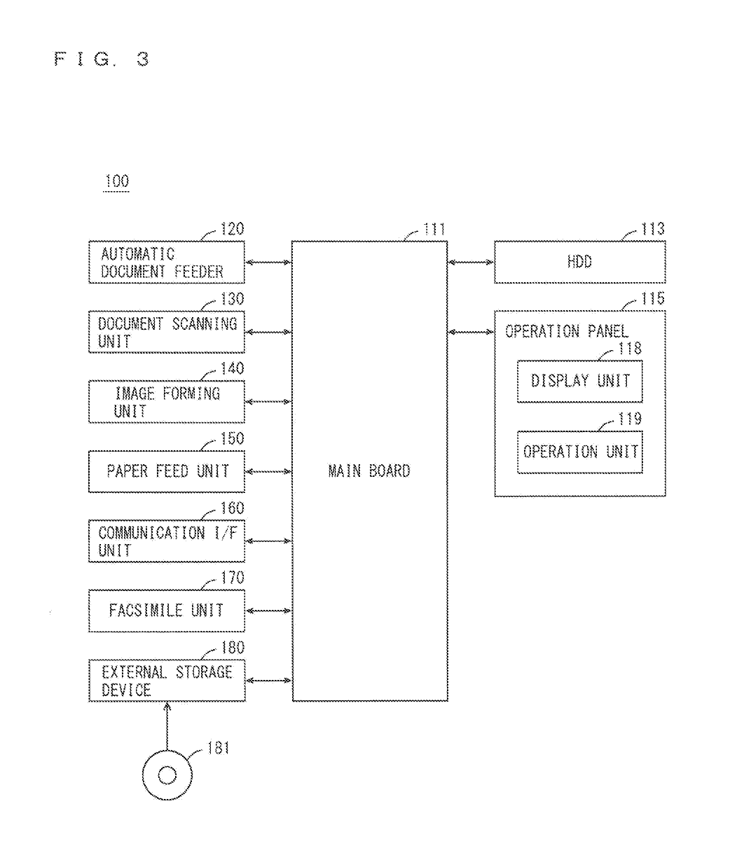

Since the hardware configuration and functions of the MFPs 100, 100A, 100B are the same, the MFP 100 is described here as an example. FIG. 3 is a block diagram showing one example of the outline of the hardware configuration of the MFP in one or more embodiments of the present invention. Referring to FIG. 3, the MFP 100 includes a main board 111, a document scanning unit 130 for scanning a document, an automatic document feeder 120 for conveying a document to the document scanning unit 130, an image forming unit 140 for forming an image on the paper or other medium based on image data output by the document scanning unit 130 that has scanned a document, a paper feed unit 150 for supplying the paper to the image forming unit 140, a communication interface (I/F) unit 160, a facsimile unit 170, an external storage device 180, a hard disc drive (HDD) 113 as a mass storage device and an operation panel 115 serving as a user interface.

The main board 111 is connected to the automatic document feeder 120, the document scanning unit 130, the image forming unit 140 and the paper feed unit 150, the communication I/F unit 160, the facsimile unit 170, the external storage device 180, the HDD 113 and the operation panel 115, and controls the entire MFP 100.

The automatic document feeder 120 automatically transports a plurality of documents set on a document feed tray to a predetermined document scanning position set on a platen glass of the document scanning unit 130 one by one, and discharges the document, the image of which has been scanned by the document scanning unit 130, onto a document discharge tray. The document scanning unit 130 includes a light source that irradiates the document that has been transported to the document scanning position with light, and an optoelectronic transducer that receives the light reflected by the document and scans the document image according to a size of the document. The optoelectronic transducer converts the received light into image data, which is an electric signal, and outputs the image data to the image forming unit 140.

The paper feed unit 150 conveys the paper stored in the paper feed tray to the image forming unit 140. The image forming unit 140 forms an image by a well-known electro photographic method. The image forming unit 140 forms an image on the paper that has been conveyed by the paper feed unit 150, based on the processed image data obtained when various data processing such as shading correction is performed on the image data received from the document scanning unit 130 or the externally received image data, and discharges the paper having an image formed thereon to the discharge tray.

The communication I/F unit 160 is an interface for connecting the MFP 100 to the network 3. The communication I/F unit 160 communicates with another computer connected to the network using a communication protocol such as a TCP or a UDP. The protocol for communication is not limited in particular, and any protocol can be used.

The communication I/F unit 160 outputs the data received from the network 3 to the main board 111, and outputs the data received from the main board 111 to the network 3. The communication I/F unit 160 outputs only the data, that is addressed to the MFP 100 out of the data received from the network 3, to the main board 111, and discards the data addressed to a device different from the MFP 100 out of the data received from the network 3.

The facsimile unit 170 is connected to the Public Switched Telephone Networks (PSTN), and transmits and receives facsimile data. The external storage device 180 is mounted with a CD-ROM 181 or a semiconductor memory. The external storage device 180 reads out the data stored in the CD-ROM 181 or the semiconductor memory. The external storage device 180 stores the data in the CD-ROM 181 or the semiconductor memory.

The operation panel 115 is provided on an upper surface of the MFP 100, and includes the display unit 118 and the operation unit 119. The display unit 118 is a display device such as a Liquid Crystal Display (LCD) device or an organic ELD, and displays instruction menus to users, information about the acquired image data, and the like. The operation unit 119 includes a plurality of hard keys and a touch panel. The touch panel is a multi-touch-capable panel superimposed on an upper or lower surface of the display unit 118 and detects the position designated by the user in the display surface of the display unit 118.

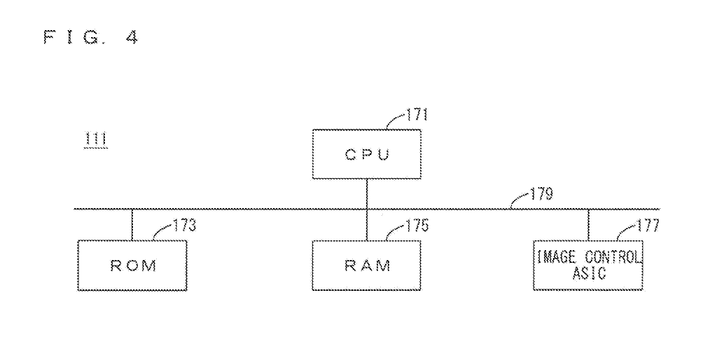

FIG. 4 is a block diagram showing one example of a detailed configuration of the main board in one or more embodiments of the present invention. Referring to FIG. 4, the main board 111 includes a CPU 171, a ROM 173, a RAM 175 and an image control ASIC (Application Specific Integrated Circuit) 177.

The CPU 171, the ROM 173, the RAM 175 and the image control ASIC 177 are respectively connected to a bus 179 and can transfer data. The CPU 171 controls the MFP 100 as a whole. The ROM 173 stores the program executed by the CPU 171. The RAM 175 is a volatile semiconductor memory that is used as a work area of the CPU 171.

The CPU 171 loads the program stored in the HDD 113 into the RAM 175 for execution. The program executed by the CPU 171 includes a control program for controlling hardware resources and an application program. The hardware resources include the automatic document feeder 120, the document scanning unit 130, the image forming unit 140, the paper feed unit 150, the communication I/F unit 160, the facsimile unit 170, the HDD 113 and the operation panel 115. The application program includes a facsimile transmission program for controlling the facsimile unit 170 to transmit facsimile data, a facsimile reception program for controlling the facsimile unit 170 and receiving facsimile data, a print program for controlling the communication I/F unit 160 to receive a print job, and controlling the image forming unit 140 and the paper feed unit 150 to form an image based on the print job, and a document scanning program for controlling the document scanning unit 130 to scan a document. Further, the application program may include a maintenance program for managing consumables included in the MFP 100 and an error state notification program for making notification of an error state. The application program executed by the CPU 171 is not limited to these.

The image control ASIC 177 is connected to and controls the automatic document feeder 120, the document scanning unit 130, the image forming unit 140 and the paper feed unit 150. Further, the image control ASIC 177 has a function of executing a predetermined image process and processing the image data output by the document scanning unit 130 that has scanned a document, and a function of converting the image data into raster data for printing by the image forming unit 140.

The server 200 in one or more embodiments of the present invention includes a simulator that simulates the MFPs 100, 100A, 100B. Since the server 200 simulates the respective MFPs 100, 100A, 100B in the same manner, the case where the server 200 simulates the MFP 100 will be described here as an example.

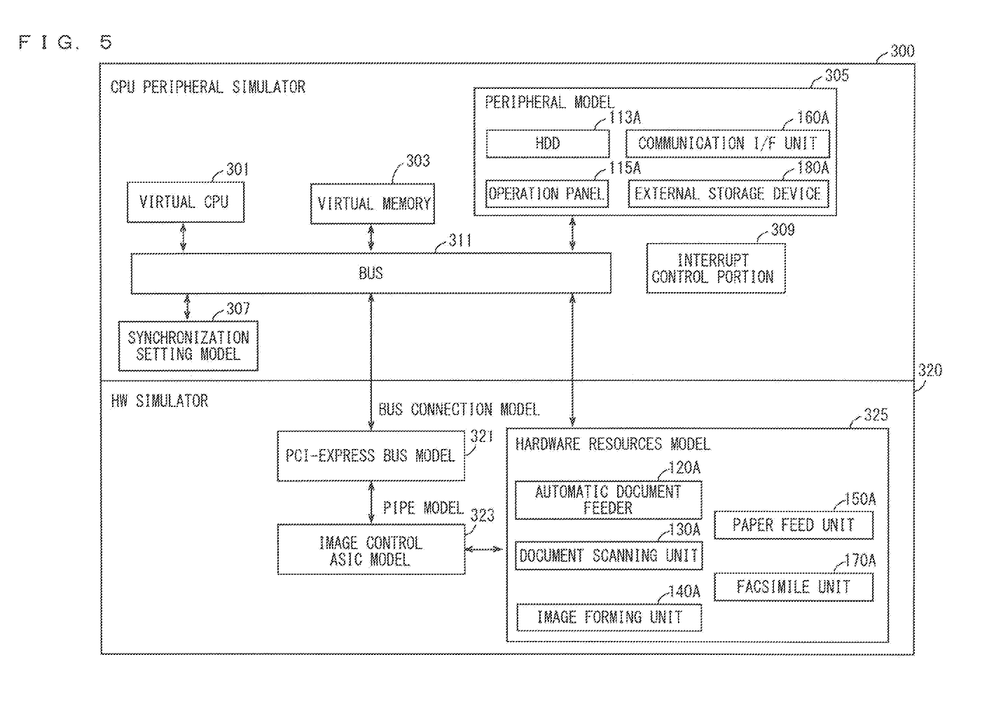

FIG. 5 is a diagram showing one example of an outline of the simulator included in the server. This simulator is formed in the CPU 201 when the CPU 201 executes a simulate program. Referring to FIG. 5, the simulator includes a CPU peripheral simulator 300 and a hardware (HW) simulator 320. The CPU peripheral simulator 300 includes a virtual CPU 301 that simulates the CPU 171 included in the MFP 100, a virtual memory 303 that emulates the ROM 173 and the RAM 175, a peripheral model 305, a synchronization setting model 307 and an interrupt control portion 309. The virtual CPU 301, the virtual memory 303, the peripheral model 305 and the synchronization setting model 307 are connected to a bus 311.

The peripheral model 305 includes an HDD 113A, an operation panel 115A, a communication I/F unit 160A and an external storage device 180A that emulate the HDD 113, the operation panel 115, the communication I/F unit 160 and the external storage device 180 that are included in the MFP 100, respectively.

The synchronization setting model 307 makes settings such that the virtual CPU 301 synchronizes with the virtual memory 303 and the peripheral model 305. When the settings are made in order for the virtual CPU 301 to synchronize with the virtual memory 303 and the peripheral model 305, the interrupt control portion 309 generates an interrupt in the virtual CPU 301.

The HW simulator 320 includes a PCI-Express Bus model 321 and an image control ASIC model 323 and a hardware resources model 325. The PCI-Express Bus model 321 is connected to the bus 311 and emulates the connection in accordance with the PCI-Express standard. The image control ASIC model 323 emulates the image control ASIC 177 included in the MFP 100. The hardware resources model 325 emulates the hardware resources included in the MFP 100. Specifically, the hardware resources model 325 includes an automatic document feeder 120A, a document scanning unit 130A, an image forming unit 140A, a paper feed unit 150A and a facsimile unit 170A that emulate the automatic document feeder 120, the document scanning unit 130, the image forming unit 140, the paper feed unit 150 and the facsimile unit 170 that are included in the MFP 100, respectively.

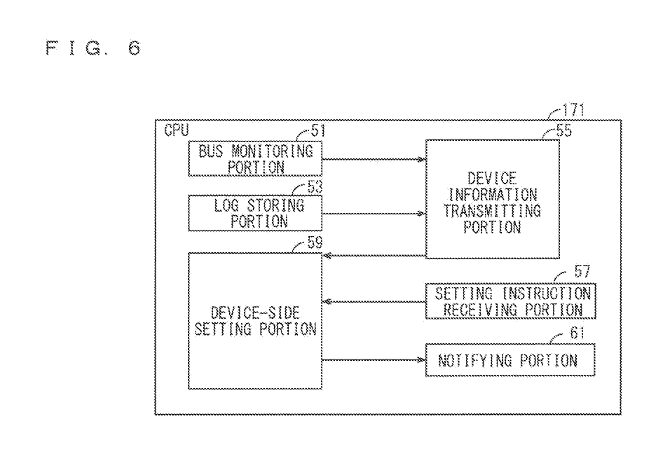

FIG. 6 is a block diagram showing one example of functions of the CPU included in the MFP in one or more embodiments of the present invention. The functions shown in FIG. 6 are implemented by the CPU 171 when the CPU 171 included in the MFP 100 executes a state notification program stored in the ROM 173, the HDD 113 or the CD-ROM 181. The state notification program is part of a device setting program. Referring to FIG. 6, the CPU 171 includes a bus monitoring portion 51, a log storing portion 53, a device information transmitting portion 55, a setting instruction receiving portion 57, a device-side setting portion 59 and a notifying portion 61.

The bus monitoring portion 51 monitors a bus 179. The bus 179 is an internal bus connected to the CPU 171. The bus monitoring portion 51 outputs a utilization rate of the bus 179 to the device information transmitting portion 55. The utilization rate is the proportion of the time during which a signal flows through the bus 179 per unit time.

The log storing portion 53 stores a log, which is the history of jobs executed by the CPU 171. The job defines a process to be executed by the CPU 171. The log includes time period information, job information and process data for each job. The time period information includes the time and date when execution of the job is started, and a time period from the start to the end of the execution of the job. The job information is the information about a job executed by the CPU 171. The job information at least includes process identification information for identifying a process defined by the job and job parameters for executing the process. The process data is the data to be processed by the CPU 171 that executes the process defined by the job. The process data includes the data received from an external device other than the MFP 100 in addition to the data produced by the MFP 100. The data produced by the MFP 100 includes the data that is output when the document scanning unit 130 scans a document, for example. The data received from the external device includes the data that has been received from the external device and stored in the HDD 113.

When the utilization rate received from the bus monitoring portion 51 becomes equal to or larger than a predetermined allowable value, the device information transmitting portion 55 produces the device information, and controls the communication I/F unit 160 to transmit the produced device information to the server 200. The allowable value is a predetermined value. The device information includes a model name of the CPU 171 provided in the MFP 100, the hardware information about the hardware resources installed in the MFP 100, the software information about the software resources installed in the MFP 100 and the log information. The hardware information includes the hardware identification information for identifying the hardware resources and hardware parameters that are set to control each of the hardware resources. In the case where there are a plurality of hardware resources, the hardware information includes the hardware identification information and hardware parameters for each of the plurality of hardware resources. The software information includes program identification information for identifying each program, and software parameters set to execute each program. In the case where there are a plurality of programs, the software information includes program identification information and software parameters for each of the plurality of programs. The log information includes a log corresponding to a job executed by the CPU 171 when the utilization rate received from the bus monitoring portion 51 becomes equal to or larger than the predetermined allowable value. The device information transmitting portion 55 extracts a log having the time period information including a time point at which the utilization rate received from the bus monitoring portion 51 becomes equal to or larger than the predetermined allowable value in the time period specified by the time period information from the log stored by the log storing portion 53 in the HDD 113, and produces the log information including the extracted log. Further, the device information transmitting portion 55 outputs the extracted log to the device-side setting portion 59.

The setting instruction receiving portion 57, the device-side setting portion 59 and the notifying portion 61 will be described below.

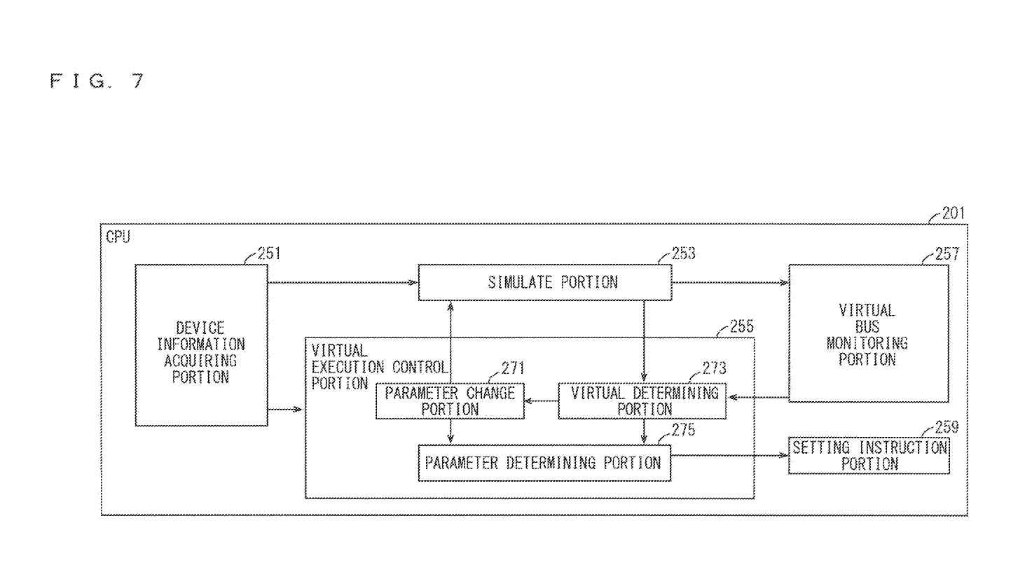

FIG. 7 is a block diagram showing one example of functions of the CPU included in the server in one or more embodiments of the present invention. The functions shown in FIG. 7 are implemented by the CPU 201 when the CPU 201 included in the server 200 executes the device setting program stored in the ROM 202, the HDD 204 or the CD-ROM 210A.

Referring to FIG. 7, the CPU 201 included in the server 200 includes a device information acquiring portion 251, a simulate portion 253, a virtual execution control portion 255, a virtual bus monitoring portion 257 and a setting instruction portion 259.

The device information acquiring portion 251 acquires device information from one of the MFPs 100, 100A, 100B. As described above, in the case where the bus utilization rate becomes equal to or larger than the allowable value, one of the MFPs 100, 100A, 100B transmits the device information. When the communication unit 205 receives the device information from one of the MFPs 100, 100A, 100B, the device information acquiring portion 251 acquires the device information received by the communication unit 205. Here, the case where the device information is acquired from the MFP 100 will be described as an example. In the case where acquiring the device information from the MFP 100, the device information acquiring portion 251 outputs the device information to the simulate portion 253 and the virtual execution control portion 255.

The virtual execution control portion 255 receives the device information from the device information acquiring portion 251. The virtual execution control portion 255 includes a parameter change portion 271, a virtual determining portion 273 and a parameter determining portion 275. The parameter change portion 271 acquires job parameters that are set for each job based on the log information included in the device information and, changes the acquired job parameter.

The log information includes a log for each of one or more jobs, and the log includes the time period information, the job information and the process data. The job information includes process identification information and job parameters. For example, in the case where the job is a print process of forming an image based on print data, the log includes the job information corresponding to the print process and the data to be used for printing as the process data. This job information includes the process identification information for identifying the print process and the parameters used for execution of the print process as job parameters. The parameters used for execution of the print process include a parameter defining resolution of an image to be printed, a parameter defining whether it is color or monochrome printing and a parameter defining the number of colors in the case of color printing, for example. The job may include an image process other than the print process. The image process is not particularly restricted, but it may be a compression process of compressing an image, a sharpening process of emphasizing an edge of an image, a process of smoothing gradation of color or the like.

In the case where the log information includes respective logs of a plurality of respective jobs, the parameter change portion 271 changes job parameters respectively corresponding to the plurality of jobs. The virtual execution control portion 255 outputs the job parameters changed by the parameter change portion 271 to the simulate portion 253. The parameter change portion 271 changes the job parameters such that a load on the CPU 171 is reduced. For example, when a data amount increases, the load on the CPU 171 may increase. Thus, the parameter change portion 271 changes the job parameters such that a data amount to be processed by the CPU 171 is reduced.

The simulate portion 253 receives the device information from the device information acquiring portion 251. The simulate portion 253 simulates the MFP 100. First, based on the device information, the simulate portion 253 makes settings of the hardware resources included in the MFP 100, allows the virtual CPU 301 to execute the software resources executed by the CPU 171 of the MFP 100, and makes settings of hardware parameters and software parameters.

The MFP 100 includes the image control ASIC 177, the automatic document feeder 120, the document scanning unit 130, the image forming unit 140, the paper feed unit 150, the communication I/F unit 160, the facsimile unit 170, the external storage device 180, the HDD 113 and the operation panel 115 as hardware resources. Therefore, the hardware information included in the device information defines the image control ASIC 177, the automatic document feeder 120, the document scanning unit 130, the image forming unit 140, the paper feed unit 150, the communication I/F unit 160, the facsimile unit 170, the external storage device 180, the HDD 113 and the operation panel 115 as the hardware resources. The simulate portion 251 makes settings of an emulator that emulates each of the image control ASIC 177, the automatic document feeder 120, the document scanning unit 130, the image forming unit 140, the paper feed unit 150, the communication I/F unit 160, the facsimile unit 170, the external storage device 180, the HDD 113 and the operation panel 115 that are defined by the hardware information included in the device information, and makes settings of the hardware parameters included in the hardware information. Further, the simulate portion 253 makes settings of synchronization of the virtual CPU 301 with the hardware resources to be emulated. For example, the simulate portion 253 allows the synchronization setting model 307 of the CPU peripheral simulator 300 shown in FIG. 5 to make settings of a register value of the virtual CPU 301 such that the virtual CPU 301 is synchronized with the emulator of the hardware resources, and rewrites a memory map of the virtual memory 303.

Further, the simulate portion 251 sets the programs defined by the software information included in the device information ready to be executed by the virtual CPU 301, and makes settings of the software parameters defined by the software information. Specifically, the simulate portion 251 installs the programs specified by the program identification information defined by the software information included in the device information, and makes settings of the software parameters defined by the software information. Thus, in the simulate portion 253, a virtual device that is a result of simulation of the MFP 100 is completed. The data stored in the RAM 175 of the MFP 100 may be acquired as a snapshot and stored in the virtual memory 303.

The simulate portion 253 can allow the virtual CPU 301 to execute the same job as the job executed by the CPU 171 of the MFP 100 based on the device information. In the case where a plurality of logs are defined by the log information included in the device information, the simulate portion 253 determines timing for executing each of a plurality of jobs, and executes each of the plurality of jobs at a determined time point, according to the time period information included in each of the plurality of logs. The time period information indicates the date and time of the start of the execution of the job and the period from the start to the end of the execution of the job, so that the simulate portion 253 determines the timing for executing the plurality of jobs according to the time and date of the start of the execution of each of the plurality of jobs. Specifically, the simulate portion 253 determines the order of execution of the plurality of jobs according to the date and time of the start of the execution of the plurality of jobs. Based on the job having the earliest date and time of the start of execution, the simulate portion 253 may determine the timing for starting the execution of the jobs that are to be executed secondarily or subsequently after that.

In the case where receiving a changed job parameter from the parameter change portion 271, the simulate portion 253 changes a job parameter set for a job to the job parameter that has been changed by the parameter change portion 271, and allows the virtual CPU 301 to execute the job corresponding to the changed job parameter.

Because simulating the MFP 100 in response to reception of the device information by the device information acquiring portion 251 from one of the MFPs 100, 100A, 100B, in this case, the MFP 100, the simulate portion 253 does not simulate the MFP 100 until the device information acquiring portion 251 receives the device information from the MFP 100. Therefore, the load on the CPU 201 of the server 200 can be as small as possible.

The virtual bus monitoring portion 257 monitors the bus 311. The bus 311 is an internal bus connected to the virtual CPU 301. The virtual bus monitoring portion 257 outputs a utilization rate of the bus 311 to the virtual determining portion 273. In the case where the utilization rate received from the virtual bus monitoring portion 257 becomes equal to or larger than the predetermined allowable value during a period in which the simulate portion 253 allows the virtual CPU 301 to execute a plurality of jobs, the virtual determining portion 273 outputs a change instruction to the parameter change portion 271. In the case where the utilization rate received from the virtual bus monitoring portion 257 does not become equal to or larger than the predetermined allowable value during the period in which the simulate portion 253 allows the virtual CPU 301 to execute the plurality of jobs, the virtual determining portion 273 outputs a determination instruction to the parameter change portion 271 and the parameter determining portion 275.

In response to reception of the change instruction from the virtual determining portion 273, the parameter change portion 271 changes the job parameter such that a new job parameter causes a smaller load on the CPU 171 than the job parameter that has been previously output to the simulate portion 253. The virtual execution control portion 255 outputs the new job parameter that is produced when the job parameter is changed by the parameter change portion 271 to the simulate portion 253. Every time receiving a new job parameter from the virtual execution control portion 255, the simulate portion 253 changes a job parameter set for a job to a new job parameter that is produced when the job parameter is changed by the parameter change portion 271, and allows the virtual CPU 301 to execute the job corresponding to the new job parameter. Therefore, every time receiving the change instruction from the virtual determining portion 273, the parameter change portion 271 determines a new job parameter. Every time a job parameter is newly changed by the parameter change portion 271, the simulate portion 253 changes a job according to a new job parameter and allows the virtual CPU 301 to execute the job. This cycle is repeated by the virtual determining portion 273 until determination is made that the utilization rate received from the virtual bus monitoring portion 257 does not become equal to or larger than the predetermined allowable value during a period in which the simulate portion 253 allows the virtual CPU 301 to execute a plurality of jobs. In this case, the image quality level is defined by three levels, high, medium and low according to a degree of effect, which a value of a job parameter has on the image quality. In response to reception of the determination instruction from the virtual determining portion 273, the parameter change portion 271 outputs a set of job identification information for identifying a job, a new job parameter and an image quality level defined by a job parameter to the parameter determining portion 275.

In the case where a job defines a plurality of job parameters, the parameter change portion 271 gives higher priority to job parameters with high predetermined priority over job parameters with low predetermined priority, and change them accordingly. For example, the job parameters that affect the image quality include compressibility, resolution and the number of colors. The priority order may be predetermined such that the smaller the effect of a job parameter has on the image quality, the higher the priority is. For example, the priority order is predetermined in the order of the compressibility, the resolution and the number of colors, for example.

The parameter determining portion 275 determines a change job parameter for each job based on sets of job identification information, a new job parameter and an image quality level received from the parameter change portion 271. In the case where there is one set including same job identification information among the sets of job identification information, a new job parameter and an image quality level, the parameter determining portion 275 determines the new job parameter included in the set as a change job parameter. In the case where there are a plurality of sets including same job identification information among the sets of job identification information, a new job parameter and an image quality level, the parameter determining portion 275 determines the new job parameter included in the set having the highest image quality level among the plurality of sets as a change job parameter. In the case where there are a plurality of sets including the highest image quality level, the parameter determining portion 275 determines a new job parameter included in any one set as a change job parameter. The new job parameter included in the set that causes the lowest utilization rate may be determined as a change job parameter. The parameter determining portion 275 determines a change job parameter for each job, and outputs a set of the process identification information for identifying a process defined by a job and a change job parameter to the setting instruction portion 259.

Here, the virtual CPU 301 that simulates the CPU 171 executes a plurality of jobs. Therefore, the parameter change portion 271 changes at least one of job parameters of the plurality of jobs. Therefore, there may be a plurality of ways of combining of a plurality of jobs in which the utilization rate detected by the virtual bus monitoring portion 257 does not become equal to or larger than the predetermined allowable value during a period in which the simulate portion 253 allows the virtual CPU 301 to execute the plurality of jobs.

For example, the case where three jobs are executed by the virtual CPU 301 is described here as an example. Here, the job identification information of the three jobs executed by the MFP 100 are referred to as a job 1, a job 2 and a job 3. First, the parameter change portion 271 changes a job parameter of one of the three jobs, and does not change job parameters of the other two jobs. The parameter change portion 271 determines the combinations of the parameters of the three jobs. The simulate portion 253 allows the virtual CPU 301 that simulates the CPU 171 to execute the three jobs. In this case, the parameter change portion 271 changes one job parameter of one job into three job parameters respectively corresponding to the three different image quality levels. Therefore, the number of combinations of the parameters of the three jobs executed by the simulate portion 253 is nine.

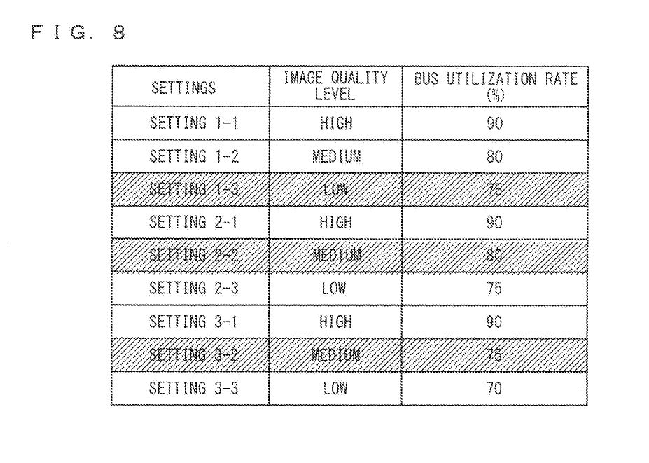

FIG. 8 is a diagram showing one example of results of simulation. FIG. 8 includes items of the settings, the image quality level and the bus utilization rate. The item of settings indicates the combination of a job and a change job parameter. The item of the image quality level indicates the image quality level of a change job parameter. The higher the image quality is, the higher the level is, and there are three levels of high, medium and low. The item of the bus utilization rate indicates the bus utilization rate.

The group of the setting 1-1, the setting 1-2 and the setting 1-3 indicates a group of three jobs with only the job parameter of the job 1 changed. The setting 1-1 has the highest level, the setting 1-2 has the second highest level and the setting 1-3 has the lowest level of the job parameter. The group of the setting 2-1, the setting 2-2 and the setting 2-3 indicates a group of three jobs with only the job parameter of the job 2 changed. The setting 2-1 has the highest level, the setting 2-2 has the second highest level and the setting 2-3 has the lowest level of the job parameter. The group of the setting 3-1, the setting 3-2 and the setting 3-3 indicates a group of three jobs with only the job parameter of the job 3 changed. The setting 3-1 has the highest level, the setting 3-2 has the second highest level and the setting 3-3 has the lowest level of the job parameter.

Here, the threshold value of the bus utilization rate is 80%. The bus utilization rate does not become equal to or larger than 80% when the setting 1-3, the setting 2-3, the setting 3-2 or the setting 3-3 is set. In this case, the parameter determining portion 275 determines a set of process identification information of the process defined by the job 1 with the setting 1-3 and a change job parameter indicating the low level, a set of process identification information of the process defined by the job 2 with the setting 2-2 and a change job parameter indicating the medium level, and a set of process identification information of the process defined by the job 3 with the setting 3-2 and a change job parameter indicating the medium level, and output them to the setting instruction portion 259. Because the setting 3-3 indicates the level lower than the level of the setting 3-2, the set of the process identification information of the process defined by the job 3 with the setting 3-3 and the change job parameter indicating the low level is not output to the setting instruction portion 259.

Returning to FIG. 7, the setting instruction portion 259 receives a set of process identification information and a change job parameter from the parameter determining portion 275. The setting instruction portion 259 controls the communication unit 205 to transmit a setting instruction to a simulation subject device, in this case, the MFP 100. The setting instruction includes the set of process identification information and a change job parameter that is received from the parameter determining portion 275. The setting instruction is a command for controlling the MFP 100 such that, in the case where a plurality of new jobs that define the same processes as the plurality of jobs specified by the log information included in the device information and define the same job parameters as or job parameters that differ from the job parameters corresponding to the plurality of jobs specified by the log information included in the device information in a predetermined manner are executed in parallel, the job parameter defined by the job defining the same process as the process defined by the process identification information included in the setting instruction among the job parameters of the plurality of new jobs is changed to the change job parameter in the setting instruction.

Returning to FIG. 6, in the case where the communication I/F unit 160 receives the setting instruction from the server 200, the setting instruction receiving portion 57 outputs the received setting instruction to the device-side setting portion 59. The device-side setting portion 59 receives a log from the device information transmitting portion 55 and receives a setting instruction from the setting instruction receiving portion 57. The log received from the device information transmitting portion 55 includes a log of the plurality of jobs that are executed in the case where the bus utilization rate detected by the bus monitoring portion 51 becomes equal to or larger than the allowable value. The device-side setting portion 59 specifies processes and job parameters of the plurality of jobs specified by the log received from the device information transmitting portion 55. Then, in the case where the CPU 171 executes a plurality of new jobs defining the same processes as the processes of the plurality of jobs specified by the log in parallel, the device-side setting portion 59 determines whether a new job is in an error predicted state (a state where an error is predicted to occur during execution of a job) before execution of the final job to be executed last out of the plurality of new jobs. The device-side setting portion 59 determines that a new job is in the error predicted state in the case where the job parameter defined by each of the plurality of new jobs is the same as the job parameter corresponding to the job defining the same process out of the plurality of jobs specified by the log. Further, the device-side setting portion 59 determines that a new job is in the error predicted state in the case where the job parameter defined by each of the plurality of new jobs is different from the job parameter corresponding to the job defining the same process out of the plurality of jobs specified by the log, and causes an increase in load on the CPU 171. The larger the data amount to be processed is, the larger the load on the CPU 171 is. Therefore, in the case where the job parameters indicate the compressibility, the resolution and the number of colors, the larger they are, the larger the load is. In the case where the compressibility, which is the job parameter, defined by a new job is equal to or larger than the compressibility of the job defining the same process out of the plurality of jobs specified by the log, the device-side setting portion 59 determines that the new job is in the error predicted state. In the case where the resolution, which is the job parameter, defined by a new job is equal to or larger than the resolution of the job defining the same process out of the plurality of jobs specified by the logs, the device-side setting portion 59 determines that the new job is in the error predicted state. In the case where the number of colors, which is the job parameter, defined by the new job is equal to or larger than the number of colors of the job defining the same process out of the plurality of jobs specified by the logs, the device-side setting portion 59 determines that the new job is in the error predicted state.

In the case where determining that a new job is in the error predicted state, the device-side setting portion 59 changes the job parameter defined by the final job to be executed last among the plurality of new jobs to the change job parameter that is included in the setting instruction and makes a set with the process identification information for identifying the process defined by the final job out of the new jobs, and then allow the CPU 171 to execute the final job.

For example, in the case where results of simulation shown in FIG. 8 are acquired, if the process identification information defined by the final job is the same as the process identification information defined by the job 1, the device-side setting portion 59 changes the job parameter of the final job to the change job parameter defined by the setting 1-3, and then allows the CPU 171 to execute the final job. If the process identification information defined by the final job is the same as the process identification information defined by the job 2, the device-side setting portion 59 changes the job parameter of the final job to the change job parameter defined by the setting 2-3, and then allow the CPU 171 to execute the final job. If the process identification information defined by the final job is the same as the process identification information defined by the job 3, the device-side setting portion 59 changes the job parameter of the final job to the change job parameter defined by the setting 3-2, and then allows the CPU 171 to execute the final job.

In the case where the change job parameter that makes a set with the process identification information for identifying the process defined by the final job is not included in the setting instruction, or the case where the job parameter that makes a set with the process identification information for identifying the process defined by the final job cannot be changed, the device-side setting portion 59 selects one from among the one or more new jobs that have been executed before the final job, and changes the job parameter defined by the selected new job to the change job parameter that is included in the setting instruction and makes a set with the process identification information for identifying the process defined by the new job selected from among the new jobs after execution of one process unit of the selected new job ends. In the case where the data including a plurality of pages is to be processed in the new job, one process unit is one page, for example.

For example, in the case where the results of simulation shown in FIG. 8 are acquired, when the job 1 is the final job, and the job parameter of the job 1 cannot be changed, the device-side setting portion 59 selects one of the job 2 and the job 3 under execution, for example, the job 2, and changes the job parameter of the job 2 to the change job parameter defined by the setting 2-3 after one process unit of the job 2 ends.

The device-side setting portion 59 outputs an notification instruction including the job identification information of the job defining the job parameter that has been changed, the change job parameter and the original job parameter before the change to the notifying portion 61.

In response to reception of the notification instruction from the device-side setting portion 59, the notifying portion 61 notifies the user who has given an instruction for executing the job specified by the job identification information included in the notification instruction that the job parameter has been changed. In the case where the user has given the instruction for executing the job by operating the operation panel 115, the notifying portion 61 displays a notification screen in the display unit 118. In the case where the user has given the instruction for executing a print job by transmitting a print job from a personal computer connected to the network 3, the notifying portion 61 controls the communication I/F unit 160 to display a notification screen in the PC. The notification screen may include the job identification information, the change job parameter and the original job parameter before the change that are included in the notification instruction. Thus, the user can predict a printing result. Further, the notifying portion 61 may display the notification screen before the device-side setting portion 59 changes the job parameter to the change job parameter, and the device-side setting portion 59 may change the job parameter to the change job parameter on the condition that the permission given by the user who views the notification screen is accepted.

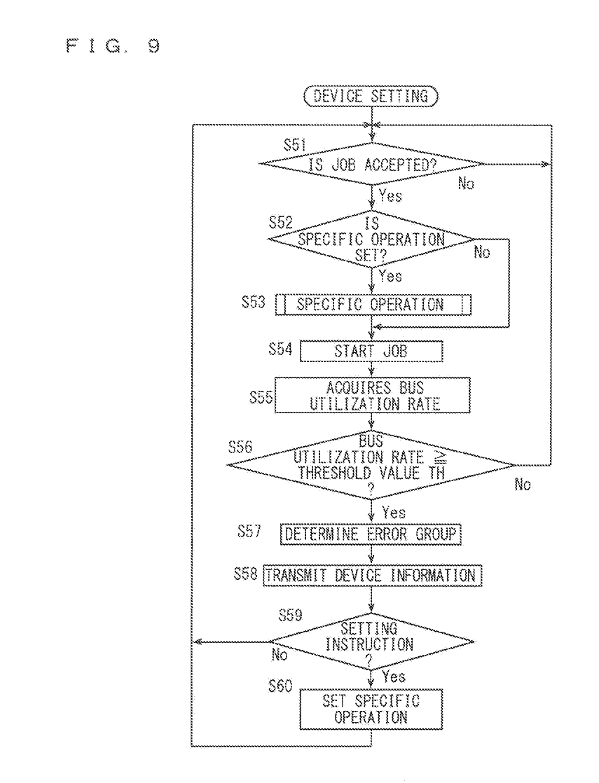

FIG. 9 is a flow chart showing one example of a flow of a device setting process. The device setting process is executed by the CPU 201 in the case where the CPU 171 included in the MFP 100 executes a device setting program stored in the ROM 173, the HDD 113 or the CD-ROM 181. Referring to FIG. 9, the CPU 171 determines whether a job has been accepted (step S51). The process waits until a job is accepted (NO in the step S51). When a job is accepted (YES in the step S51), the process proceeds to the step S52. When the communication I/F unit 160 receives a job from an external PC or the like, the CPU 171 accepts the job. Further, in the case where the operation unit 119 accepts a user operation of inputting a job, the CPU 171 accepts the job. In the step S52, the CPU 171 determines whether the settings are made to allow the execution of the specific operation. The settings are made in the step S61, described below, to allow the execution of the specific operation. If the settings are made to allow the execution of the specific operation, the process proceeds to the step S53. If not, the process proceeds to the step S54. In the step S53, the CPU 171 executes a specific operation process, and the process proceeds to the step S54. The specific operation process will be described below. In the step S54, the CPU 171 starts the job accepted in the step S51, and the process proceeds to the step S55.

In the step S55, the CPU 171 acquires the bus utilization rate, and the process proceeds to the step S56. In the step S56, the CPU 171 determines whether the bus utilization rate is equal to or larger than the threshold value TH. If the bus utilization rate is equal to or larger than the threshold value TH, the process proceeds to the step S57. If not, the process returns to the step S51.

In the step S57, the group including the plurality of jobs executed by the CPU 171 is determined as an error group, and the process proceeds to the step S58. In the step S58, the CPU 171 produces the device information and transmits the device information to the server 200. The CPU 171 produces the device information including the plurality of jobs determined to be included in the error group in the step S57, the hardware information and the software information. Then, the CPU 171 controls the communication I/F unit 160 to transmit the device information to the server 200.

In the next step S59, the CPU 171 determines whether a setting instruction has been received from the server 200. The setting instruction is a command for making settings to allow the execution of the specific operation. If the setting instruction is received, the process proceeds to the step S60. If not, the process returns to the step S51. In the step S60, the CPU 171 makes settings to allow the execution of the specific operation in accordance with the setting instruction, and the process returns to the step S51.

While details of the setting instruction will be described below, the setting instruction is a command for setting the MFP 100 to allow execution of the specific operation in the MFP 100. The specific operation is an operation of changing a job parameter defined by a job defining the same process as the process defined by the process identification information included in the setting instruction out of the job parameters of the plurality of new jobs to a change job parameter included in the setting instruction in the case where the plurality of new jobs, that define same processes as those of the plurality of jobs included in the error group and have the same job parameters or the job parameters that differ in a predetermined manner, are executed in parallel.

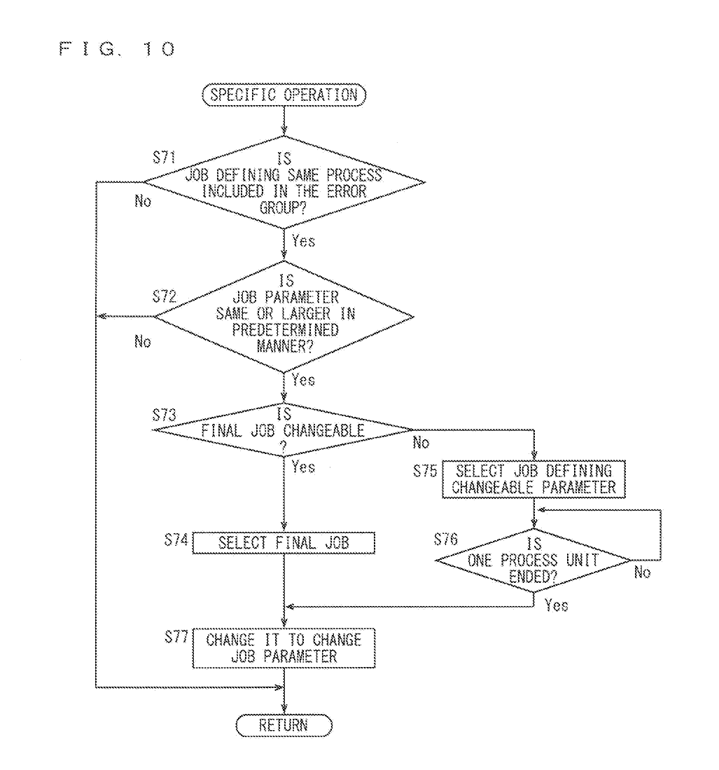

FIG. 10 is a flow chart showing one example of the specific operation process. The specific operation process is the process executed in the step S53 of FIG. 9. Referring to FIG. 10, the CPU 171 determines whether each of the processes of a plurality of execution jobs that include one or more jobs being executed by the CPU 171 and the job accepted in the step S51 is the same as each of the processes of the plurality of jobs included in the error group (step S71). If the job defining the same process as the process of each of the plurality of execution jobs is included in the error group, the process proceeds to the step S73. If not, the process returns to the state notification process. In the step S72, as for each of the plurality of execution jobs, the CPU 171 determines whether the job parameter defined by the execution job is the same as the job parameter defined by the job defining the same process out of the plurality of jobs included in the error group, or differs in a predetermined manner. If the job parameter defined by the execution job is the same as the job parameter defined by the job defining the same process out of the plurality of jobs included in the error group, or differs in the predetermined manner, the process proceeds to the step S73. If not, the process returns to the state notification process. When the job parameter differs in the predetermined manner, the job parameter causes an increase in load on the CPU 171. For example, in the case where the job parameter indicates the data amount, the load increases when the data amount of the data to be processed increases. Thus, the predetermined manner means the manner in which the job parameter causes an increase in data amount.

In the step S73, the CPU 171 determines whether the job parameter of the final job accepted in the step S51 of FIG. 9 is changeable. The job accepted in the step S51 of FIG. 9 is the job accepted last among the plurality of execution jobs. If the job parameter of the final job is changeable, the process proceeds to the step S74. If not, the process proceeds to the step S75.

In the step S74, the final job is selected as a change subject, and the process proceeds to the step S77. In the step S75, the CPU 171 determines one execution job defining a changeable job parameter from among the plurality of execution jobs as a change subject, and the process proceeds to the step S76. In the case where the process proceeds to the step S76, the execution job selected as the change subject is under execution by the CPU 171. In the step S76, the process waits until execution of one process unit of the execution job selected as the change subject ends in the CPU 171 (NO in the step S76). If the execution of one process unit ends (YES in the step S76), the process proceeds to the step S77.

In the step S77, the CPU 171 changes the job parameter of the execution job that is selected as the change subject in the step S74 or the step S75 to the change job parameter, and the process returns to the state notification process.

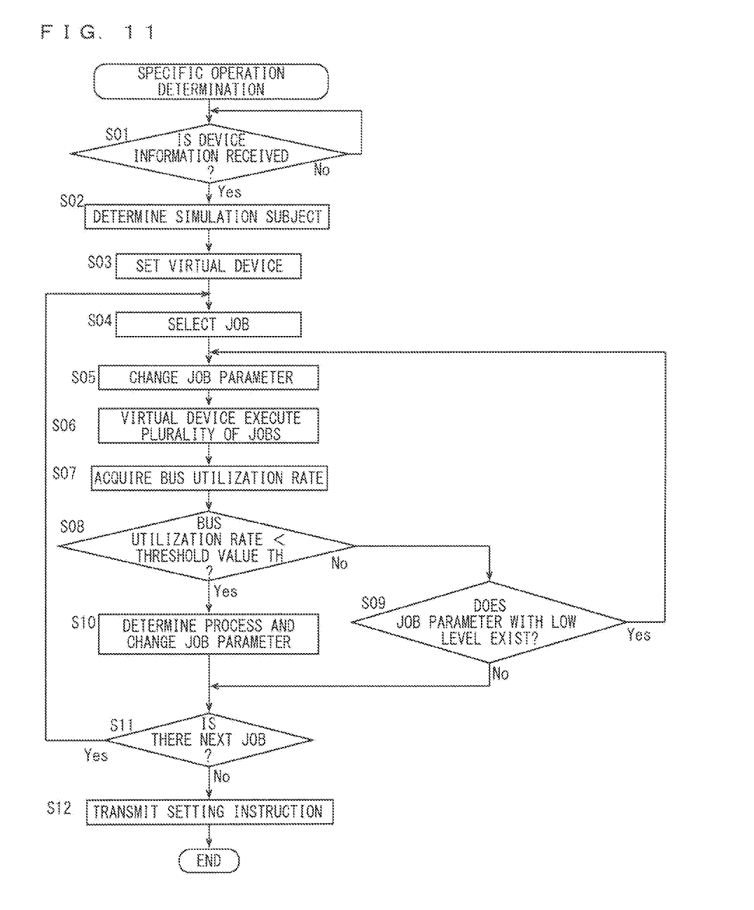

FIG. 11 is a flow chart showing one example of a flow of a specific operation determination process. The specific operation determination process is a process executed by the CPU 201 in the case where the CPU 201 included in the server 200 executes a specific operation determination program stored in the ROM 202, the HDD 204 or the CD-ROM 209. The specific operation determination program is part of the device setting program. Referring to FIG. 11, the CPU 201 included in the server 200 determines whether the device information has been received (step S01). When the communication unit 205 receives the device information from one of the MFPs 100, 100A, 100B, the CPU 201 determines that the device information has been received. The process waits until the device information is received (NO in the step S01). If the device information is received, (YES in the step S01), the process proceeds to the step S02.

In the step S02, the CPU 201 determines that the device that has transmitted the device information is a simulation subject, and the process proceeds to the step S03. The case where the communication unit 205 receives the device information from the MFP 100 will be described here as an example. In this case, the MFP 100 is determined as the simulation subject. In the step S03, the CPU 201 makes settings of a virtual device. The CPU 201 simulates the MFP 100 that is the simulation subject based on the device information received in the step S01. Specifically, the CPU 201 make settings of an emulator that emulates the hardware resources defined by the hardware information included in the device information, and makes settings such that the software resources defined by the software information included in the device information are ready to be executed by the virtual CPU 301.

In the next step S04, the CPU 201 selects a job defining the parameter to be changed from among the plurality of jobs defined by the log information included in the device information. Then, the CPU 201 changes the job parameter defined by the selected job. The CPU 201 changes the job parameter to a parameter a lower than the job parameter. In the step S06, the CPU 201 executes the plurality of jobs in the virtual device. The CPU 201 executes the plurality of jobs defined by the log information in the virtual device. However, the CPU 201 executes the job selected in the step S04 as the job defining the job parameter that is changed in the step 505.

In the step S07, the CPU 201 acquires the bus utilization rate. Then, the CPU 201 determines whether the bus utilization rate is smaller than the threshold value TH (step S08). If the bus utilization rate is smaller than the threshold value, the process proceeds to the step S10. If not, the process proceeds to the step S09. In the step S10, the CPU 201 determines a process and a change job parameter, and the process proceeds to the step S11. The CPU 201 determines the process defined by the job selected in the step S04, and determines the change job parameter that is defined for the process and is changed in the step S05 as the change job parameter.

In the step S09, the CPU 201 determines whether the job parameter that is lower than the job parameter that is changed in the step S05 exists. If a lower job parameter exists, the process returns to the step S05. If not, the process proceeds to the step S11. In the step S11, the CPU 201 determines whether a job to be processed next exists. If a job that is not selected as a job to be processed in the S04 exists, the process returns to the step S04. If not, the process proceeds to the step S12.

In the step S12, the CPU 201 controls the communication unit 205 to transmit the setting instruction to the device determined as a simulation subject, in this case, the MFP 100, and ends the process. The setting instruction includes a set of process identification information and a change job parameter of the process determined in the step S10. The setting instruction is a command for controlling the MFP 100 such that, in the case where a plurality of new jobs defining same processes as the processes defined by the plurality of jobs specified by the log information included in the device information received in the step S01 and defining the same job parameters or the job parameters that differ in a predetermined manner, are executed in parallel, the job parameter defined by the job defining the same process as the process defined by the process identification information included in the setting instruction among the job parameters defined by the plurality of new jobs to the change job parameter included in the setting instruction.

### First Modified Example

The setting instruction transmitted by the setting instruction portion 259 to the MFP 100 that is a simulate subject may include a set of process identification information, a change job parameter and an image quality level that are received from the parameter determining portion 275.

In the case where determining that a new job is in the error predicted state, the device-side setting portion 59 selects one set with the highest image quality level from among the sets of the process identification information, the new job parameter and the image quality level included in the setting instruction, and specifies the process identification information and the new job parameter that are included in the selected set. Then, the setting instruction portion 259 selects a job including the specified process identification information from among a plurality of new jobs. In the case where the selected new job is a final job, the device-side setting portion 59 changes the job parameter defined by the final job to the new job parameter that makes a set with the process identification information for identifying the process defined by the final job out of the new job parameters included in the setting instruction, and then allows the CPU 171 to execute the final job. In the case where the selected new job is not the final job, the device-side setting portion 59 changes the job parameter defined by the selected new job to the new job parameter that makes a set with the process identification information for identifying the process defined by the new job selected from among the new job parameters included in the setting instruction after execution of one process unit of the selected new job ends.

### Second Modified Example

In the case where the virtual CPU 301 that simulates the CPU 171 executes a plurality of jobs, the CPU 201 may change a job parameter of each of at least two of the plurality of jobs. As described above, in the case where the CPU 201 changes the job parameter defined by one job out of the plurality of jobs, a job parameter defining the bus utilization rate that does not become equal to or larger than a predetermined allowable value exists. However, in the case where the job parameter defining the image quality level that is equal to or higher than the medium level does not exist, the CPU 201 changes a job parameter of each of at least two of the plurality of jobs. Further, in the case where the CPU 201 changes the job parameter defined by one job out of the plurality of jobs, when the job parameter defining the bus utilization rate that does not become equal to or larger than the predetermined allowable value does not exist, the CPU 201 changes a job parameter of each of at least two of the plurality of jobs. There may be a plurality of ways of combining a plurality of jobs in which the utilization rate detected by the virtual bus monitoring portion 257 does not become equal to or larger than the predetermined allowable value during a period in which the simulate portion 253 allows the virtual CPU 301 to execute the plurality of jobs.

For example, the case where three jobs are executed by the virtual CPU 301 is described as an example.

First, the parameter change portion 271 changes a job parameter of each of two jobs out of the three jobs, and allows the virtual CPU 301 to execute the three jobs. In this case, the parameter change portion 271 changes a job parameter defined by one job into three job parameters respectively corresponding to three different image quality levels. Therefore, the parameter change portion 271 changes one job parameter into three job parameters for each of the two jobs out of the three jobs, so that the number of combinations of the three jobs executed by the simulate portion 253 is twenty seven.

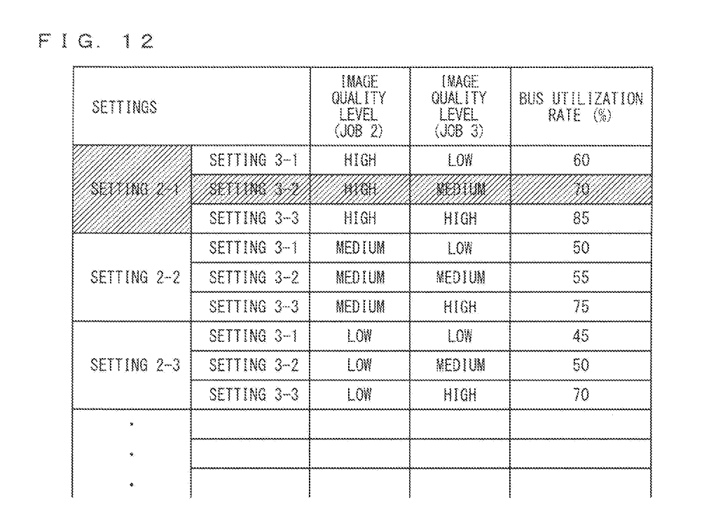

FIG. 12 is a diagram showing part of one example of results of simulation when settings are changed for two jobs. FIG. 12 shows three combinations of the setting 2-1 combined with each one of the setting 3-1, the setting 3-2 and the setting 3-3, three combinations of the setting 2-2 combined with each one of the setting 3-1, the setting 3-2 and the setting 3-3, and three combinations of the setting 2-3 combined with each one of the setting 3-1, the setting 3-2 and the setting 3-3.

In FIG. 12, the bus utilization rate becomes equal to or larger than 80% when the setting 2-1 is combined with the setting 3-3. In this case, as for the combination of the settings for the job 2 and the job 3, the parameter determining portion 275 selects one from among the combinations excluding the combination of the setting 2-1 and the setting 3-3, and outputs the selected combination to the setting instruction portion 259. In this case, the parameter determining portion 275 gives higher priority to the combination that does not have the low image quality level and has the larger number of high image quality level. Here, the parameter determining portion 275 selects the combination of the setting 2-1 and the setting 3-2.

In addition to the groups shown in FIG. 12, there are nine ways of combining the settings for the job 1 and job 2 and nine ways of combining the settings for the job 1 and the job 3.

Further, the parameter change portion 271 may change the job parameter of each of the three jobs, and may allow the virtual CPU 301 to execute the three jobs. In this case, the parameter change portion 271 changes one job parameter of one job into three job parameters respectively corresponding to the three different image quality levels. Therefore, the parameter change portion 271 changes one job parameter of each of the three jobs into three job parameters, so that there are twenty seven ways of combining the three jobs executed by the simulate portion 253.

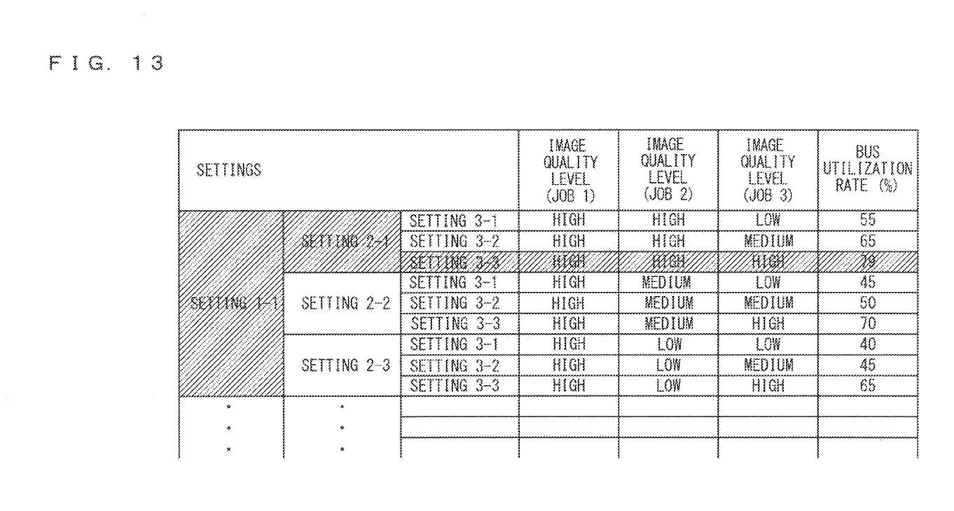

FIG. 13 is a diagram showing part of one example of the results of simulation when the settings of the three jobs are changed. FIG. 13 shows three combinations of the setting 1-1, the setting 2-1 and one of the setting 3-1, the setting 3-2 and the setting 3-3, three combinations of the setting 1-1, the setting 2-2 and one of the setting 3-1, the setting 3-2 and 3-3, and three combinations of the setting 1-1, the setting 2-3 and one of the setting 3-1, the setting 3-2 and the setting 3-3.

There is no combination of settings that results in the bus utilization rate being equal to or larger than 80%. In this case, as for the combination of the setting 1-1 of the job 1 and the settings of the job 2 and the job 3, the parameter determining portion 275 selects one combination from among the plurality of combinations, and outputs the combination to the setting instruction portion 259. In this case, as for the combination of settings of the job 1, the job 2 and the job 3, the parameter determining portion 275 gives higher priority to the combination not having the low image quality level and having the larger number of high image quality levels. Here, the parameter determining portion 275 selects the combination of the setting 1-1, the setting 2-1 and the setting 3-3.

In addition to the groups shown in FIG. 13, there are nine ways of combining the settings for the setting 1-2 of the job 1 and the settings of the job 2 and the job 3, and nine ways of combining the settings for the setting 1-3 of the job 1 and the settings of the job 2 and the job 3.

The parameter change portion 271 outputs the set that results in the utilization rate being equal to or larger than the threshold value of 80% out of two or more sets of job identification information, a new job parameter and an image quality level to the parameter determining portion 275.

The parameter determining portion 275 selects one of the plurality of combinations received from the parameter change portion 271 based on the image quality level. The parameter determining portion 275 gives higher priority to the combination that at least does not have the low image quality level when selecting. In the case where there are a plurality of combinations that at least do not have the low image quality level, the parameter determining portion 275 selects the combination having the largest number of the high image quality level from among the plurality of combinations. The parameter determining portion 275 selects the combination of the setting 2-2 and the setting 3-3 in the example shown in FIG. 13.

The parameter determining portion 275 selects one set including the change job parameters for the plurality of jobs, and outputs a set of process identification information for identifying the process defined by each of the plurality of jobs and a change job parameter to the setting instruction portion 259.

As for each of a plurality of new jobs, in the case where it is determined that a new job is in the error predicted state, the device-side setting portion 59 changes a job parameter corresponding to the process specified by the process identification information included in the setting instruction to the change job parameter that makes a set with the process identification information, and executes the plurality of jobs.

As described above, in the case where a preset allowable condition is unsatisfied by an operation state of the MFP 100, the server 200 in one or more embodiments of the present invention determines a group of the plurality of jobs being executed by the MFP 100 as an error group, allows a virtual device that simulates the MFP 100 to execute the plurality of jobs corresponding to at least one changed parameter out of the plurality of jobs included in the error group in parallel, and determines the group of the plurality of jobs executed by the virtual device in the case where the allowable condition is not unsatisfied by the operation state of the virtual device as a change job group. Therefore, a job parameter that results in the allowable condition not being unsatisfied by the operation state of the MFP 100 can be selected for the plurality of jobs that result in the allowable condition being unsatisfied by the operation state of the MFP 100. Then, in the case where the MFP 100 executes a plurality of new jobs in parallel, the plurality of new jobs defining the same processes as those defined by the plurality of jobs that belong to the error group and defining the job parameters that are the same job parameters or different job parameters that cause an increase in load, settings are made in the MFP 100 such that the job parameters of the plurality of new jobs are changed to the job parameters defined by the plurality of jobs included in the change job group. Thus, the settings can be made in the MFP 100 such that the allowable condition is not unsatisfied in the case where the MFP 100 executes the plurality of jobs.

Further, when the server 200 makes settings in the MFP 100, the job parameters of the plurality of new jobs are changed to the job parameters defined by the plurality of jobs included in the change job group in the case where the MFP 100 executes the plurality of new jobs in parallel, the plurality of jobs defining the same processes as those defined by the plurality of jobs that belong to the error group and defining the same job parameters or different job parameters that cause an increase in load. Thus, the MFP 100 can allow the allowable condition not to be unsatisfied in the case where executing the plurality of jobs.

Further, the server 200 gives higher priority to the job parameters with the high predetermined priority over the job parameters with the low predetermined priority and change them. Therefore, degradation of data to be processed in the job can be as little as possible.

Further, the MFP 100 transmits the error group to the server 200 and requests the determination of the change job group. When receiving a request from the MFP 100, the server 200 simulates the MFP 100 and determines the change job group. This prevents an increase in load on MFP 100 when the MFP 100 executes a process of determining the change job group.

In the case where the job defining the job parameter to be changed out of the plurality of new jobs is a final job, the job parameter of the final job is changed before execution of the final job starts. Therefore, the MFP 100 can continuously execute a job other than the final job.

In the case where the job defining the job parameter that is to be changed out of the plurality of new jobs is not the final job, the MFP 100 changes the job parameter when execution of one process unit of the job defining the parameter to be changed ends. Therefore, the job parameter defined by the job under execution can be changed during execution.

The MFP 100 notifies the user of the job defining the job parameter to be changed and the change of the job parameter defined by the job before changing at least one job parameter of the plurality of new jobs. Therefore, the user can confirm the job that is to have the different output results and the contents of change.

In the above-mentioned embodiments, the server 200 is shown as one example of the simulation device, and the MFP 100 is shown as one example of the information processing apparatus. However, it is needless to say that the present invention can be specified as the device setting method of allowing the MFP 100 to execute the device setting process shown in FIGS. 9 and 10 and allowing the server 200 to execute the specific operation determination process shown in FIG. 11. Also, it is needless to say that the present invention can be specified as the device setting program of allowing the CPU 171 of the MFP 100 to execute the device setting process shown in FIGS. 9 and 10, and the specific operation determination program of allowing the CPU 201 of the server 200 to execute the specific operation determination process shown in FIG. 11.

Although embodiments of the present invention have been described and illustrated in detail, the disclosed embodiments are made for purpose of illustration and example only and not limitation. The scope of the present invention should be interpreted by terms of the appended claims.

What is claimed is:

1. A simulation device comprising a hardware processer that:
simulates an information processing apparatus that executes a job that defines a process and a parameter that indicates contents of the process;
when an operation state of the information processing apparatus that carries out parallel execution of a plurality of jobs does not satisfy a preset allowable condition, determines a group of the plurality of jobs being executed by the information processing apparatus as an error group;
allows a virtual device that simulates the information processing apparatus to carry out parallel execution of a plurality of jobs that are generated when a parameter defined by at least one of the plurality of jobs included in the error group is changed;
when an operation state of the virtual device satisfies the allowable condition, determines a group of the plurality of jobs executed by the virtual device as a change job group; and
when the information processing apparatus carries out parallel execution of a plurality of new jobs, allows the information processing apparatus to change each of parameters of the plurality of new jobs to a parameter defined by a change job included in the change job group,
wherein processes of the plurality of new jobs are same as processes of the plurality of jobs that belong to the error group,
wherein parameters of the plurality of new jobs are same as or different in a predetermined manner from the parameters of the plurality of jobs that belong to the error group, and
wherein a process of the change job is same as a process of the new job, out of a plurality of change jobs included in the change job group.

2. The simulation device according to claim 1, wherein
the hardware processor further changes a parameter with higher predetermined priority before a parameter with lower predetermined priority.

3. An information processing apparatus comprising a hardware processer that:
when an operation state of the information processing apparatus does not satisfy a preset allowable condition during parallel execution of a plurality of jobs, each of which defines a process and a parameter that indicates contents of the process, determines a group of the plurality of jobs as an error group;
determines a group that includes a plurality of jobs, at least one of which defines a parameter different from a parameter defined by a corresponding job of the plurality of jobs included in the error group and satisfies the allowable condition during parallel execution, as a change job group; and
when a plurality of new jobs are executed, changes each of parameters of the plurality of new jobs to a parameter defined by a change job included in the change job group,
wherein processes of the plurality of new jobs are same as processes of the plurality of jobs that belong to the error group,
wherein parameters of the plurality of new jobs are same as or different in a predetermined manner from the parameters of the plurality of jobs that belong to the error group, and
wherein a process of the change job is same as a process of the new job, out of a plurality of change jobs included in the change job group.

4. The information processing apparatus according to claim 4, wherein
the hardware processor further:
transmits the error group to a server;
requests determination of the change job group; and
allows the server to simulate the information processing apparatus,
the server allows a virtual device that simulates the information processing apparatus to carry out parallel execution of a plurality of jobs that are generated when a parameter defined by at least one of the plurality of jobs included in the error group is changed, and
when an operation state of the virtual device satisfies the allowable condition, the hardware processor allows the server to determine the group of a plurality of jobs executed by the virtual device as the change job group.

5. The information processing apparatus according to claim 3, wherein
when a job that defines a parameter to be changed out of the plurality of new jobs is a final job that is executed last, the hardware processor changes the parameter of the final job to a parameter defined by the change job before executing the final job,
wherein a process of the change job is same as a process of the final job, out of a plurality of change jobs included in the change job group.

6. The information processing apparatus according to claim 3, wherein
when a job that defines a parameter to be changed out of the plurality of new jobs is not a final job that is executed last, the hardware processor changes the parameter to be changed of the job to a parameter defined by the change job when execution of one process unit of the job that defines the parameter to be changed ends,
wherein a process of the change job is same as a process of the job, out of a plurality of change jobs included in the change job group.

7. The information processing apparatus according to claim 3, wherein
before changing at least one parameter of the plurality of new jobs, the hardware processor further notifies a user of a job that defines a parameter that is to be changed out of parameters of the plurality of new jobs and a change of the parameter of the job.

8. A device setting method including:
simulating an information processing apparatus that executes a job that defines a process and a parameter that indicates contents of the process;
when an operation state of the information processing apparatus that carries out parallel execution of a plurality of jobs does not satisfy a preset allowable condition, determining a group of the plurality of jobs being executed by the information processing apparatus as an error group;
allowing a virtual device that simulates the information processing apparatus to carry out parallel execution of a plurality of jobs that are generated when a parameter defined by at least one of the plurality of jobs included in the error group is changed;
when an operation state of the virtual device satisfies the allowable condition, determining a group of the plurality of jobs executed by the virtual device as a change job group; and
when the information processing apparatus carries out parallel execution of a plurality of new jobs, allowing the information processing apparatus to change each of parameters of the plurality of new jobs to a parameter defined by a change job included in the change job group,
wherein processes of the plurality of new jobs are same as processes of the plurality of jobs that belong to the error group,
wherein parameters of the plurality of new jobs are same as or differ in a predetermined manner from the parameters of the plurality of jobs that belong to the error group, and
wherein a process of the change job is same as a process of the new job, out of a plurality of change jobs included in the change job group.

9. The device setting method according to claim 8, further including changing a parameter with higher predetermined priority before a parameter with lower predetermined priority.

10. A device setting method including:
when an operation state of an information processing apparatus does not satisfy a preset allowable condition during parallel execution of a plurality of jobs, each of which defines a process and a parameter that indicates contents of the process, determining a group of the plurality of jobs as an error group;
determining a group that includes a plurality of jobs, at least one of which defines a parameter different from a parameter defined by a corresponding job of the plurality of jobs included in the error group and satisfies the allowable condition during parallel execution, as a change job group; and
when a plurality of new jobs are executed, changing each of parameters of the plurality of new jobs to a parameter defined by a change job included in the change job group,
wherein processes of the plurality of new jobs are same as processes of the plurality of jobs that belong to the error group,
wherein parameters of the plurality of new jobs are same as or differ in a predetermined manner from the parameters of the plurality of jobs that belong to the error group, and
wherein a process of the change job is same as a process of the new job, out of a plurality of change jobs included in the change job group.

11. The device setting method according to claim 10, further including:
transmitting the error group to a server;
requesting determination of the change job group; and
allowing the server to simulate the information processing apparatus,
wherein
the server allows a virtual device that simulates the information processing apparatus to carry out parallel execution of a plurality of jobs that are generated when a parameter defined by at least one of the plurality of jobs included in the error group is changed, and
when an operation state of the virtual device satisfies the allowable condition, the server determines the group of a plurality of jobs executed by the virtual device as the change job group.

12. The device setting method according to claim 10, including:
when a job that defines a parameter to be changed out of the plurality of new jobs is a final job that is executed last, changing the parameter of the final job to a parameter defined by the change job before executing the final job,
wherein a process of the change job is same as a process of the final job, out of a plurality of change jobs included in the change job group.

13. The device setting method according to claim 10, including:
when a job that defines a parameter to be changed out of the plurality of new jobs is not a final job that is executed last, changing the parameter to be changed of the job to a parameter defined by a change job when execution of one process unit of the job that defines the parameter to be changed ends,
wherein a process of the change job is same as a process of the job, out of a plurality of change jobs included in the change job group.

14. The device setting method according to claim 10, further including:
notifying a user of a job that defines a parameter that is to be changed out of parameters of the plurality of new jobs and a change of the parameter of the job before changing at least one parameter of the plurality of new jobs.

15. A non-transitory computer-readable recording medium encoded with a device setting program allowing a computer to:
simulate an information processing apparatus that executes a job that defines a process and a parameter that indicates contents of the process;
when an operation state of the information processing apparatus that carries out parallel execution of a plurality of jobs does not satisfy a preset allowable condition, determine a group of the plurality of jobs being executed by the information processing apparatus as an error group;
allow a virtual device that simulates the information processing apparatus to carry out parallel execution of a plurality of jobs that are generated when a parameter defined by at least one of the plurality of jobs included in the error group is changed;
when an operation state of the virtual device satisfies the allowable condition, determine a group of the plurality of jobs executed by the virtual device as a change job group; and
when the information processing apparatus carries out parallel execution of a plurality of new jobs, allow the information processing apparatus to change each of parameters of the plurality of new jobs to a parameter defined by a change job included in the change job group,
wherein processes of the plurality of new jobs are same as processes of the plurality of jobs that belong to the error group,
wherein parameters of the plurality of new jobs are same as or differ in a predetermined manner from the parameters of the plurality of jobs that belong to the error group, and
wherein a process of the new job is same as a process of the new job, out of a plurality of change jobs included in the change job group.

16. A non-transitory computer-readable recording medium encoded with a device setting program,
the device setting program allowing a computer to:
when an operation state of an information processing apparatus does not satisfy a preset allowable condition during parallel execution of a plurality of jobs, each of which defines a process and a parameter that indicates contents of the process, determine a group of the plurality of jobs as an error group;
determine a group that indicates a plurality of jobs, at least one of which defines a parameter different from a parameter defined by a corresponding job of the plurality of jobs included in the error group and satisfies the allowable condition during parallel execution, as a change job group; and
when a plurality of new jobs are executed, changing each of parameters of the plurality of new jobs to a parameter defined by a change job included in the change job group,
wherein processes of the plurality of new jobs are same as processes of the plurality of jobs that belong to the error group,
wherein parameters of the plurality of new jobs are same as or differ in a predetermined manner from the parameters of the plurality of jobs that belong to the error group, and
wherein a process of the change job is same as a process of the new job, out of a plurality of change jobs included in the change job group.
